(19) United States
(12) Patent Application Publication
(10) Pub. No.: US 2006/0143689 A1
(43) Pub. Date: Jun. 29, 2006

(54) Information flow enforcement for RISC-style assembly code

(75) Inventors: Dachuan Yu, Santa Clara, CA (US); Nayeem Islam, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: DoCoMo Communications Laboratories USA, Inc.

(21) Appl. No.: 11/316,621

(22) Filed: Dec. 19, 2005

Related U.S. Application Data
(60) Provisional application No. 60/638,298, filed on Dec. 21, 2004.

(51) Int. Cl. H04L 9/00

(52) U.S. Cl. 726/1

(57) ABSTRACT

A method, article of manufacture and apparatus for performing information flow enforcement are disclosed. In one embodiment, the method comprises receiving securely typed native code and performing verification with respect to information flow for the securely typed native code based on a security policy.

### PRIORITY

The present patent application claims priority to and incorporated by reference the corresponding provisional patent application Ser. No. 60/638,298, titled, “Information Flow Enforcement for RISC-Style Assembly Code”, filed on Dec. 21, 2004.

### FIELD OF THE INVENTION

The present invention is related to the field of program execution and security; more specifically, the present invention is related to enforcing information flow constraints on assembly code.

### BACKGROUND OF THE INVENTION

It is well-known that traditional security mechanisms are insufficient in enforcing information flow policies. In recent years, much effort has been put on protecting the confidentiality of sensitive data using techniques based on programming language theory and implementation. These techniques analyze the flow of information inside a target system, and have the potential to overcome the drawbacks of many traditional security mechanisms. Unfortunately, the vast amount of language-based research on information flow still does not address the problem for assembly code or machine executables directly. The challenge there largely lies in working with the lack of high-level abstractions (e.g., program structures and data structures) and managing the extreme flexibility offered by assembly code (e.g., memory aliasing and first-class code pointers).

Nonetheless, it is desirable to enforce noninterference directly at a low-level. On the one hand, any high-level programs must be compiled into low-level code before they can be executed on a real machine. Compilation or optimization bugs may invalidate the security guarantee established for the source program, and potentially be exploited by a malicious party. On the other hand, some applications are distributed (e.g., bytecode or native code for mobile computation) or even directly written (e.g., embedded systems, core system libraries) in assembly code. Hence enforcement at a low-level is sometimes a must.

With the growing reliance on networked information systems, the protection of confidential data becomes increasingly important. The problem is especially subtle for a computing system that both manipulates sensitive data and requires access to public information channels. Simple policies that restrict the access to either the sensitive data or the public channels (or a combination thereof) often prove too restrictive. A more desirable policy is that no information about the sensitive data can be inferred from observing the public channels, even though a computing system is granted access to both. Such a regulation of the flow of information is often referred to as information flow, and the policy that sensitive data should not affect public data is often called noninterference.

Whereas it is relatively easy to detect and prevent naive violations that directly give out sensitive data, it is much more difficult to prevent an application from sending out information that is sophisticatedly encoded. Traditional security mechanisms such as access control, firewalls, encryption and anti-virus fall short on enforcing the noninterference policy. On the one hand, noninterference posts seemingly conflicting requirements for conventional mechanisms: it allows the use of sensitive information, but restricts the flow of it. On the other hand, the violation of noninterference cannot be observed from monitoring a single execution of the program, yet such execution monitoring serves as the basis of many conventional mechanisms.

The problem of information flow can be abstracted as a program that operates on data of different security levels, e.g., low and high. Low data (representing low security) are public data that can be observed by all principles; high data (representing high security) are secret data whose access is restricted. An information flow policy requires that no information about the high (secret) input can be inferred from observing the low (public) output. In general, the security levels can be generalized to a lattice.

Such an information flow policy concerns tracking the flow of information inside a target system. Although it is easy to detect explicit flows (e.g., through an assignment from a secret h to a public l with l=h), it is much harder to detect various forms of implicit flow. For example, the statement l=0; if h then l=1 involves an implicit flow of information from h to l. At runtime, if the then branch is not taken, a conventional security mechanism based on execution monitoring will not detect any violation. However, information about h can indeed be inferred from the result of l, because the fact that l remains 0 indicates that the value of h must also be 0.

Instead of observing a single execution, language-based techniques derive an assurance about the program's behavior by examining, and possibly instrumenting, the program code. In the above example, the information essentially leaks through the program counter (referred to herein as pc)—the fact that a branch is taken reflects information about the guard of the conditional. In response, a security type system typically tags the program counter with a security label. If the guard of a conditional concerns high data, then the branches are verified under a program counter with a high security label. Furthermore, no assignment to a low variable is allowed under a high program counter, preventing the above form of implicit flow.

Traditional Mechanisms

Many traditional security mechanisms are based on execution monitoring (EM). Some representative examples include security kernels, reference monitors, access control and firewalls. These mechanisms enforce security by monitoring the execution of a target system, looking for potential violations to a security policy. Unfortunately, such EM can only enforce “safety properties”. An information flow policy is not a “property” (whether an execution satisfies a policy depends on other possible executions), and hence cannot be enforced by EM.

Cryptographic protocols depend on unproven complexity-theoretic assumptions. Some of these assumptions have been shown to be false (e.g., DES, SHA0, MD5). Commercial use of strong cryptography is also entangled in political and legal complications. Perhaps more importantly, cryptography only ensures the security of the communication channel, establishing that the code comes from a certain source. It alone cannot establish the safety of the application.

Anti-virus is another widely applied approach. Its limitation is well-known, namely, it is always one step behind the virus, because it is based on detecting certain patterns in the virus code.

Mandatory Access Control

Mandatory access control is a runtime enforcement mechanism developed by Fenton and Bell and LaPadula, and prescribed by the “orange book” of the US Department of Defense for secure systems. In this approach, simple confidentiality policies are encoded using security labels. Data items and the program execution are tagged with these labels. The flow of information is controlled based on these labels, which are manipulated and computed at runtime.

An obvious weakness of mandatory access control is that it incurs computational and storage overhead to calculate and store security labels. Perhaps more importantly, the enforcement is based on observing the runtime execution of the program. As discussed above, such runtime enforcement cannot effectively detect implicit flows that concern all possible execution paths of the program.

To obtain confidentiality in the presence of implicit flows, a process of using sensitivity labels is introduced. If the execution of the program may split into different paths based on confidential data, the process sensitivity labels is increased. This effect of monotonically increasing labels is known as label creep. It makes mandatory access control too restrictive to be generally useful, because the result of the label computation tend to be too sensitive for the intended use of the data.

Language-Based Approaches

Even though there has been much work that applies language-based techniques to information flow, most of them focused on high-level languages. Many high-level abstractions have been formally studied, including functions, exceptions, objects, and concurrency, and practical implementations have been carried out. Nonetheless, enforcing information flow at only a high level puts the compiler into the trusted computing base (TCB). Furthermore, the verification of software distributed or written in low-level code cannot be overlooked.

Barthe et al., in Security types preserving compilation, Proc. 5th International Conference on Verification, Model Checking and Abstract Interpretation, volume 2937 of LNCS, pages 2-15. Springer-Verlag, January 2004, presents a security-type system for a bytecode language and a translation that preserves security types. This reference discloses a stack-based language. More importantly, their verification circumvents a main difficulty—the lack of program structures at a low-level—by introducing a trusted component that computes the dependence regions and postdominators for conditionals. This component is inside the TCB and must be trusted.

Avvenuti et al., in Java bytecode verification for secure information flow, ACM SIGPLAN Notices, 38(12):20-27, December 2003, applied abstract interpretation to enforce information flow for a stack-based bytecode language. Besides the difference in the machine models, their work also relied on the computation of control flow graphs and postdominators.

Zdancewic and Myers, in Secure information flow via linear continuations, Higher-Order and Symbolic Computation, 15(2-3):209-234, September 2002, use linear continuations to enforce noninterference at a low-level. Their language is based on variables and still much different from assembly language. In particular, linear continuations, although useful in enforcing a stack discipline that helps information flow analysis, is absent from conventional assembly code. Hence, further (trusted) compilation to native code is required.

Traditionally, certifying compilation is mostly carried out for standard type safety properties (e.g., TAL, PCC, ECC). Certifying compilation has been applied to security policies. However, such systems is based on security automata, hence cannot enforce noninterference. Besides the work on security-type preserving compilation by Barthe et al. as discussed above, related issues for π-calculus with security types have also been studied. There remains no related solution proposed targeting RISC-style assembly code.

### SUMMARY OF THE INVENTION

A method, article of manufacture and apparatus for performing information flow enforcement are disclosed. In one embodiment, the method comprises receiving securely typed native code and performing verification with respect to information flow for the securely typed native code based on a security policy.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A is a flow diagram of a process for information flow enforcement.

FIG. 1B illustrates an environment in which the information flow enforcement of FIG. 1A may be implemented.

FIG. 2 illustrates a simple security system at a source language level.

FIG. 3 is a flow diagram of some program structures.

FIG. 4 illustrates an example of information flow through aliasing.

FIG. 5 illustrates example information flow through code pointer.

FIG. 6 illustrates example context coercion without branching.

FIG. 7 illustrates the benefit of low-level verification.

FIG. 8 is a flow diagram of managing security levels.

FIG. 9 is a flow diagram of establishing noninterference.

FIG. 10 is a flow diagram of verification of a program.

FIG. 11 is a flow diagram of verification of an instruction sequence.

FIG. 12 illustrates syntax of TAL_{C}.

FIG. 13 illustrates operations semantics of TAL_{C}.

FIG. 14 illustrates TAL_{C} typing judgments.

FIG. 15 illustrates TAL_{C} typing rules of non-instructions.

FIG. 16 illustrates typing rules of TAL_{C} instructions.

FIG. 17A illustrates expression translation (part of certifying compilation)

FIG. 17B illustrates program and procedure declaration translation (part of certifying compilation).

FIG. 17C illustrates command translation (part of certifying compilation).

FIG. 18 illustrates an example of a security-polymorphic function.

FIG. 19 is a block diagram of one embodiment of a mobile device.

FIG. 20 is a block diagram of one embodiment of a computer system.

### DETAILED DESCRIPTION OF THE PRESENT INVENTION

A type system for low-level information flow analysis is disclosed. In one embodiment, the system is compatible with Typed Assembly Language, and models key features of RISC code including memory tuples and first-class code pointers. A noninterference theorem articulates that well-typed programs respect confidentiality. A security-type preserving translation that targets the system is also presented, as well as its soundness theorem. This illustrates the application of certifying compilation for noninterference. These language-based techniques are promising for protecting the confidentiality of sensitive data. For RISC style assembly code, such low-level verification is desirable because it yields a small trusted computing based. Furthermore, many applications are directly distributed in native code.

Embodiments of the present invention focus on RISC-style assembly code. In one embodiment, typing annotations are used to recover information about high-level program structures, and do not require extra trusted components for computing postdominators. Furthermore, the techniques set forth herein do not rely on extra constructs such as linear continuations or continuation stacks. An erasure semantics reduces programs in our language to normal assembly code.

As set forth below, a language-based approach is used in which the enforcement is based on analyzing the program code statically. It does not require computation and storage of security labels at runtime. Furthermore, inspecting the program code and annotations allows the detection of implicit flows without falling into the label creep.

Embodiments of the present invention addresses information flow enforcement at the assembly level. To the authors' knowledge, it is the first that enforces confidentiality directly for RISC-style assembly code.

In one embodiment, a Confidentially Typed Assembly Language (TAL_{C}) is used for information flow analysis and its proof of noninterference. In one embodiment, the system is designed to be compatible with Typed Assembly Language (TAL). It thus approaches a unified framework for security and conventional type safety.

In one embodiment, the system models key features of an assembly language, including heap and register file, memory tuples (aliasing), and first-class code pointers (higher-order functions). In this document, we discuss a formal result with a core language supporting the above features for ease of understanding, but also informally discuss extensions such as, for example, polymorphic and existential types.

Although it is desirable to directly verify at an assembly level, it is more practical to develop programs in high-level languages. In one embodiment, a formal translation is presented from a security-typed imperative source language to TALC is performed. This illustrates the application of certifying compilation for noninterference. A type-preservation theorem is presented for the translation.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Challenges of Assembly Code

There are a number of challenges in enforcing information flow for assembly code. First, high-level languages make use of virtually infinite number of variables, each of which can be assigned a fixed security label. In assembly code, the use of memory cells is similar. However, a finite number of registers are reused for different source level variables, as long as the liveness regions of the variables do not overlap. As a result, one cannot assign a fixed security label to a register.

Second, the control flow of an assembly program is not as structured. The body of a conditional is often not obvious, and generally indeterminable, from the program code. Hence the idea of using a security context to prevent implicit flow through conditionals cannot be easily carried out.

Third, assembly languages are very expressive. Aliasing between memory cells can be difficult to understand. The support for first-class code pointers (i.e., the reflection of higher-order functions at an assembly level) is very subtle. A code pointer may direct a program to different execution paths, even though no branching instruction is immediately present. Nonetheless, it is important to support these features, because even the compilation of a simple imperative language with only first-order procedures can require the use of higher-order functions—returning is typically implemented as an indirect jump through a return register.

Fourth, since it is not practical to always directly program in an assembly language, a low-level type system must be designed so that the typing annotations can be generated automatically, e.g., through certifying compilation. The type system must be as least as expressive as a high-level type system, so that any well-typed source program can be translated into a well-typed assembly program.

Finally, it is desirable to include erasure semantics where type annotations have no effect at runtime. A security mechanism cannot be generally applied in practice if it incurs too much overhead. Similarly, it is also undesirable to change the programming model for accommodating the verification needs. Such a model change indicates either a trusted compilation process or a different target machine.

Overview of Information Flow Enforcement for Assembly Code

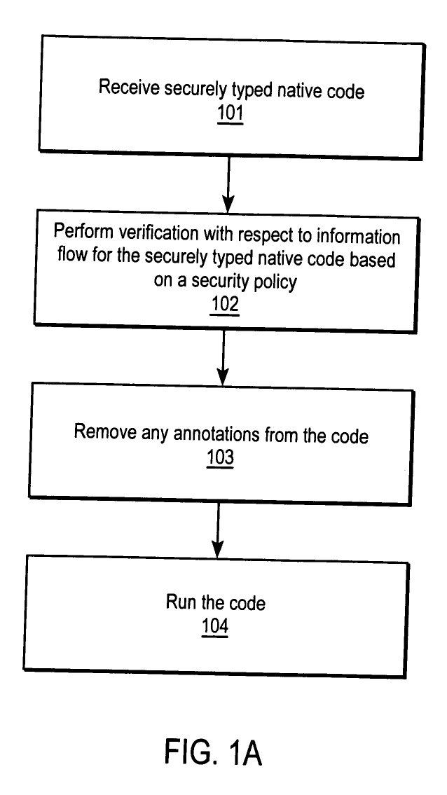

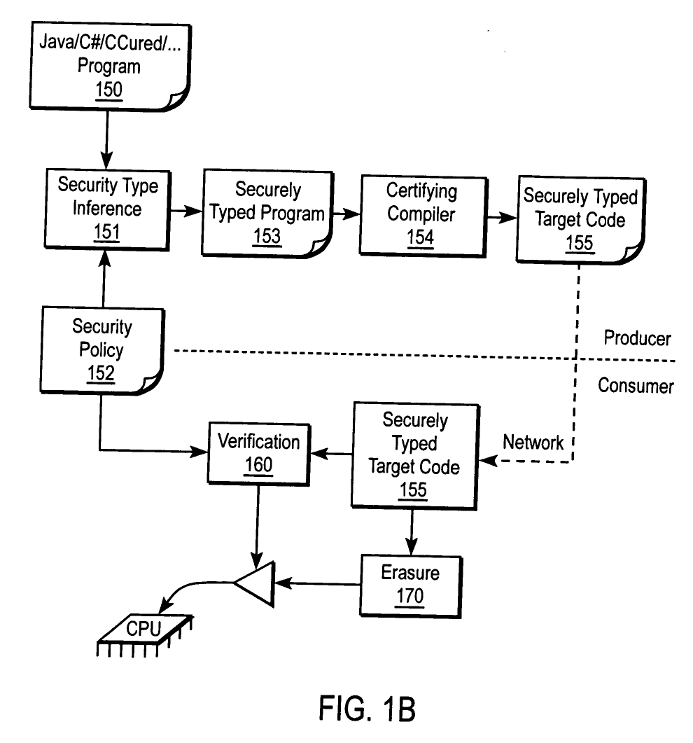

FIG. 1A is a flow diagram of a process for information flow enforcement. The process is performed by processing logic that may comprise hardware (e.g., circuitry, dedicated logic, etc.), software (such as is run on a general purpose computer system or a dedicated machine), or a combination of both.

Referring to FIG. 1A, the process begins by processing logic receiving securely typed native code (processing block 101). In one embodiment, processing logic receives the code via downloading or retrieving the code from a network location.

In one embodiment, the securely typed native code comprises assembly code that has undergone a security-type preserving translation that includes annotating the assembly code with type information. The annotations may comprise operations to mark a beginning and an ending of a region of the code in which two execution paths based on predetermined information are encountered.

After receiving the code, processing logic performs verification with respect to information flow for the securely typed native code based on a security policy (processing block 102). Verification is performed on a device (e.g., a mobile device such as a cellular phone) prior to the device running the code. In one embodiment, processing logic performs verification by statically checking behavior of the code to determine whether the code does not violate the security policy. In one embodiment, the code does not violate the security (safety) policy if the code, when executed, would not cause information of an identified type to flow from a device executing the code. In other words, it verifies the information flow that would occur under control of the assembly code when executed.

If verification determines the code does not violate the security policy, processing logic removes any annotations from the code (processing block 103) and runs the code (processing logic 104).

FIG. 1B illustrates an environment in which the information flow enforcement of FIG. 1A may be implemented. Referring to FIG. 1B, a program 150 is subjected to a security type inference 151 based on a security policy 152. The result is a securely typed program 153. A certifying compiler 154 compiles program 153 and, as a result, produces securely typed target code 155.

Securely typed target code 155 may be downloaded by a consumer device. The consumer device may be a cellular phone or other mobile device, such as, for example, described below. The consumer device runs a verification module 160 on securely typed target code 155 before running code 155. The verification module 160 performs the verification based on security policy 152, acting as a type checker.

The consumer device also runs an erasure module 170 on securely typed target code 155 to erase annotations that were added to the code by certifying compiler 154 before running code 155.

If the verification module 160 determines that the code is safe or otherwise verifies the code is acceptable based on security policy 152, verification module 160 signals the consumer device that securely typed target code 155 may be run by the consumer device (e.g., a processor on the consume device).

The following discussion describes in detail the information flow problem and the solution.

A High-Level Security Type System

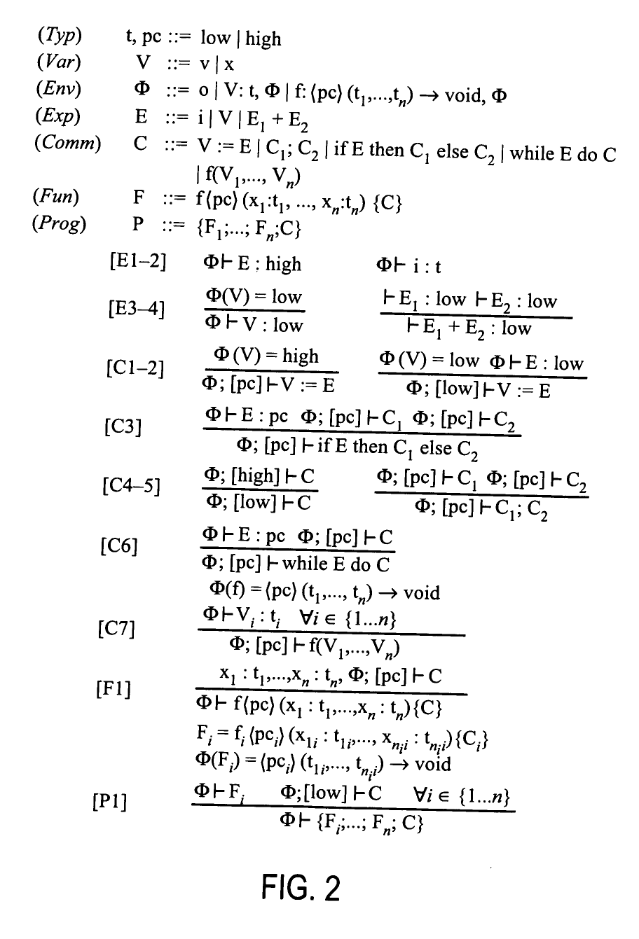

FIG. 2 shows an example of a two-level security-type system for a simple imperative language with first-order procedures. A program P comprises a list of procedure declarations Fᵢ and a main command C. A procedure declaration documents the security level of the program counter with pc, indicating that the procedure body will only update variables with security levels no less than pc. A procedure also declares a list of arguments xᵢ under call-by-reference semantics. Commands C consist of assignments, sequential compositions, conditional statements, while-loops, and procedure calls. Variables V cover both global variables v and procedure arguments x. Expressions E are formed by constants (i), variables, and their additions.

Referring to FIG. 2, Rules [E1-4] relate expressions to security types (levels). Any expression may have type high (it is secure to treat any data as sensitive). Constants and low variables may have type low. An addition expression have type low if both sub-expressions have type low.

Rules [C1-7] track the security level of the program counter (pc) when verifying the commands. Assignments to high variables are always valid (Rule [C1]). However, an assignment to a low variable is valid only if both the expression and the pc are low (Rule [C2]). For a conditional (Rule [C3]), the security level of the sub-commands must match the security level of the guard expression; together with Rule [C2], this guarantees that low variables are not modified within a branch under a high guard. After a conditional, it is useful to reset the pc to low, avoiding a form of label creep, where monotonically increasing security labels are too restrictive to be generally useful. Such a context reset is achieved with a subsumption rule (Rule [C4]); intuitively, if it is secure to execute a command in a sensitive context, then it is also secure in an insensitive one. A sequential composition is verified so that both sub-commands are valid under the given pc (Rule [C5]). The handling of a while-loop is similar to that of a conditional statement (Rule [C6]). A procedure call is valid if pc matches the expected security level, and the arguments have the expected types (Rule [C7]); note that only variables (v or x) may server as the arguments, which are handled by reference (also know as “in-out” arguments)

Finally, a procedure declaration is valid if the body can be verified under the expected PC and arguments (Rule [F1]). A program is valid if all procedure declarations and the main command are valid (Rule [P1]).

Explicit Assignment

One way of transferring information in a high-level language is through assignment. As discussed above, variables in a high-level language can be “tagged” with security labels such as low and high. The security-type system prevents label mismatch for assignments. At an assembly level, memory cells can be tagged similarly. When storing into a memory cell, a typing rule ensures that the security label of the source matches that of the target.

Regulating information flow through registers is different, because registers can be reused for different variables with different security labels. Since variable and liveness information is not available at an assembly level, one cannot easily base the enforcement upon that.

In fact, a similar problem arises even for normal type safety. A register in Type Assembly Language (TAL) can have different types at different program points. These types are essentially inferred from the computation itself. For instance, in an addition instruction add r_{d}, rₛ, rₜ, the register r_{d} is given the type int, because only int can be valid here. Similarly, when loading from a memory cell, the target register is given the type of the source memory cell. We adapt such inference for security labels. In the addition add r_{d}, rₛ, rₜ, the label of r_{d} is obtained by joining the labels of rₛ and rₜ, because the result in r_{d} reflects information from both rₛ and rₜ. Moving and memory reading instructions are handled similarly.

Program Structure

A conditional statement in a high-level program can be verified so that both subcommands respect the security level of the guard expression. Such verification becomes difficult in assembly code, where the “flattened” control flow provides little help in identifying the program structure. A conditional is typically translated into a branching instruction (bnz r, l) and some code blocks, where the postdominator of the two branches are no longer apparent.

In one embodiment, annotations are used to restore the program structure by pointing out the postdominators whenever they are needed. Note that high-level programs provide sufficient information for deciding the postdominators, and these postdominators can always be statically determined. For instance, the end of a conditional command is the postdominator of the two branches. Hence, a compiler can generate the annotations automatically based on a securely typed source program. In one embodiment of the system of the present invention, the postdominator annotation is a static code label paired with a security label.

Since branching instructions (bnz r, l) are the only instructions that could directly result in different execution paths, it would appear that one should enhance branching instructions with postdomonators. The typing rule then checks both branches under a proper security context that takes into account the guard expression. Such a security context terminates when the postdominator is reached.

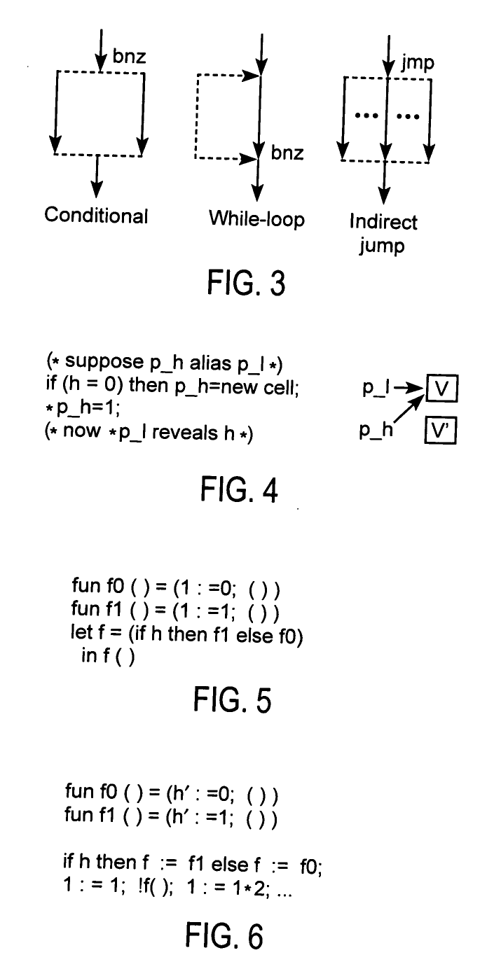

Although plausible, this approach is awkward. FIG. 3 demonstrates three scenarios. Besides the conditional scenario, branching instructions are also used to implement while-loops, where the postdominator is exactly the beginning of one of the branches. In this case, only the other branch should be checked under a new security context. If the branching instruction is directly annotated, the corresponding typing rule would be “overloaded.” More importantly, an assembly program may contain “implicit branches” where no branching instruction is present. The third scenario illustrates that an indirect jump may lead the program to different paths based on the value of its operand register. A concrete example will appear below.

Inspiration of a better solution lies in the simple system of FIG. 2. Note that the subsumption rule [C4] is not tied to any particular commands. It essentially marks a region of computation where the security level is raised from low to high. The end of the region is exactly a postdominator. Following this, in one embodiment, the approach set forth herein mimics the high-level subsumption rule with two low-level raising and lowering operations that explicitly manipulate the security context and mark the beginning and end of the secured region.

Memory Aliasing

Aliasing of memory cells present another channel for information transfer. In FIG. 4, a low pointer p_l and a high pointer p_h are aliases of the same cell (they are two pointers pointing to the same value). The code in the same figure may change the aliasing relation based on some high variable h by letting p_h point to another cell. Further modification through p_h may or may not change the value stored in the original cell. As a result, observing through the low pointer p_l gives out information about the high variable h.

The problem lies in the assignment through the high pointer p_h, because it reveals information about the aliasing relation. In one embodiment, pointers are tagged with two security labels. One is for the pointer itself, and the other is for the data being referenced. In one embodiment, assignments to low data through high pointers are not allowed. This is a conservative approach—all pointers are considered as potential aliases.

Code Pointers

Code pointers further complicate information flow. FIG. 5 shows a piece of functional code where f represents different functions based on a high variable h. In its reflection at an assembly level, different code labels will be assigned to f based on the value of h. Naturally, f contains sensitive information and should be labeled high. However, the actual functions f0 and f1 can only be executed under a low context, because they modify a low variable l. In this case, the invocation to f should be prohibited.

In one embodiment of the system of the present invention, similar to data pointers, code pointers are also given two security labels. The typing rules ensure that no low function is called through a high code pointer.

Security Context Coercion

FIG. 6 shows a piece of code where a mutable code pointer complicates the flow analysis. Functions f0 and f1 only modify high data. A reference cell f is assigned different code pointers within a high conditional. Later, the reference cell f is dereferenced and invoked in a low context.

This code is safe with respect to information flow. At a high level, a subsumption rule like Rule [C4] in FIG. 2 allows calling the high function !f( ) in a low context. However, in its assembly counterparts, both the calling to f and the returning from f are implemented as indirect jumps. The calling sequence transfers the control from a low context to a high context, whereas the returning sequence does the opposite. Since the function invocation is no longer atomic at an assembly level, one cannot directly devise a subsumption rule. Furthermore, there is no explicit branching instruction present when f is dereferenced and invoked (the third scenario of FIG. 3).

In one embodiment of the system of the present invention, the raising and lowering operations explicitly mark the boundary of the subsumption rule. During certifying compilation, the source-level typing and program structure provide sufficient information for generating the target-level annotations. When a subsumption rule is applied in the source code, the corresponding target code is generated within a pair of raising and lowering operations.

Enforcing Information Flow Policies

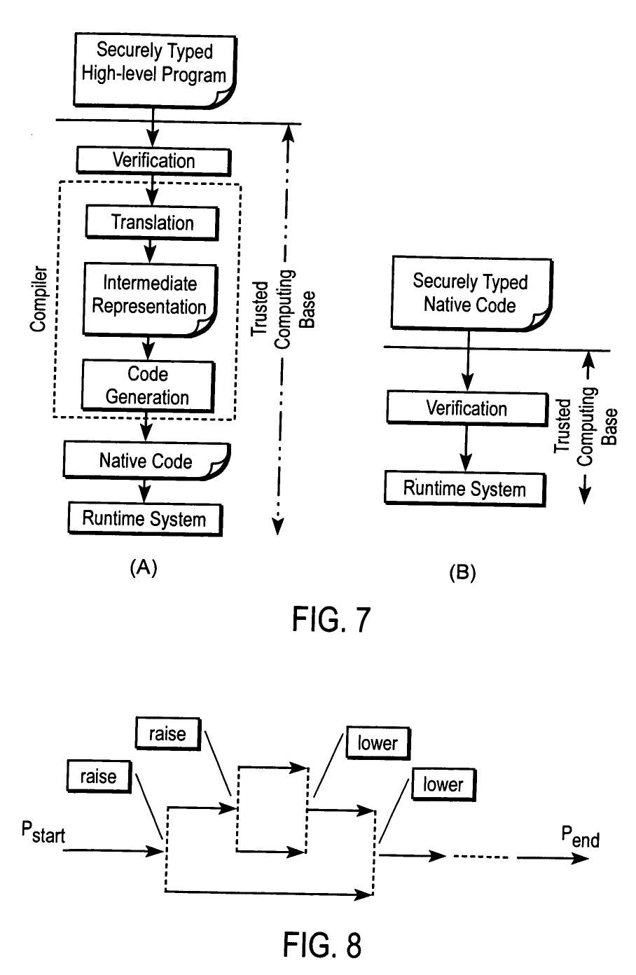

As discussed above, embodiments of the present invention enforce information flow policies directly for assembly code. A benefit of this approach is illustrated in FIG. 7A and B. As shown in FIG. 7A, existing language-based approaches enforce information flow using security-type system for high-level languages (e.g., Java). Verification is achieved at the source level only. However, a high-level program must be compiled before executing on a real machine. A compiler performs most of the transformation, including generating the native code. Translation or optimization bugs may invalidate the security guarantee established for the source program. As a result, such source-level verification relies on a huge trusted computing base.

In contrast, a security-type system is set forth herein for verifying assembly code directly. As shown in FIG. 7B, verification is achieved on securely typed native code. This removes much of the compiler out of the trusted computing base, thereby achieving a trustworthy environment. Furthermore, this allows the security verification of programs directly distributed in native code.

An embodiment of the security-type system of the present invention relies on a security context to prevent implicit flows that result from the program structure. The security context is explicitly manipulated by two operations raise and lower. FIG. 8 illustrates an example path. At the point where a program may branch into different execution paths based on sensitive data, the security context is raised high enough to capture the sensitivity of the data. In FIG. 8, this occurs at point 801 and 802 in the program that runs from P_{START} to P_{end}. At the place where the different execution paths join together (i.e., a postdominator), the security context is lowered to its original level. In FIG. 8, this occurs at points 803 and 804 in the program that runs from Pₛₜₐᵣₜ to P_{end}. Hence, the program code can be statically viewed as organized into different security regions, whose beginning and ending are explicitly marked by raise and lower.

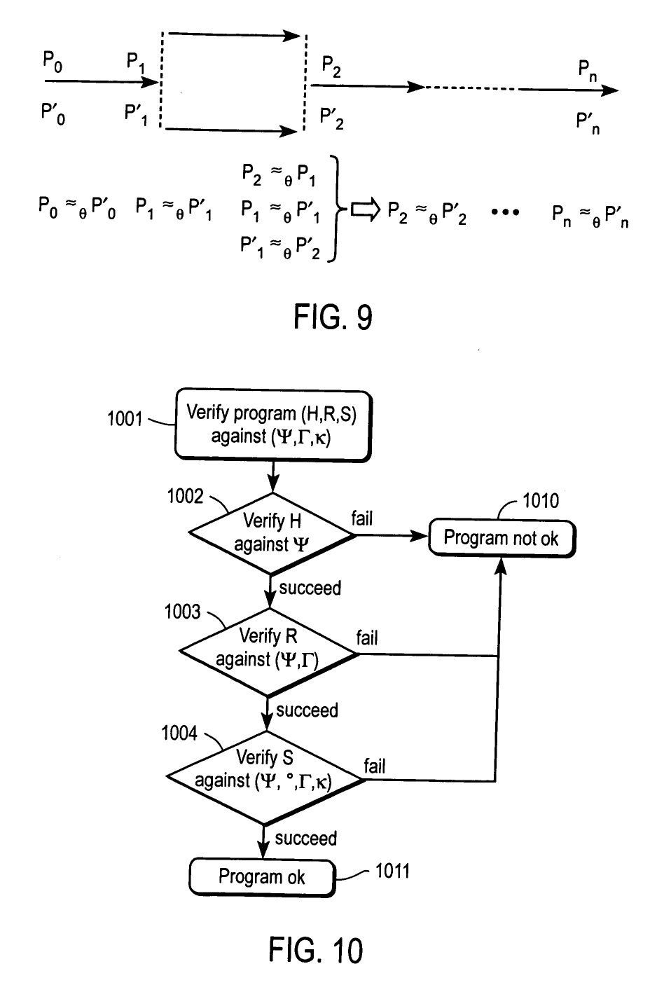

Given a security level θ of concern, any data item can be viewed as either public or secret, based on the comparison between its security level and θ. The desired noninterference result is that public output data reflects no information about secret input data. In one embodiment, a noninterference result is established based on an equivalence relation ≈_{θ}. Intuitively, two machine states are equivalent with respect to security level θ if they contain the same public data. FIG. 9 shows two execution paths of the same program based on different, but equivalent, inputs. Under a low security context, the two executions match each other in a lock-step manner. Under a high security context, the two executions may involve different code. However, an embodiment of the system of the present invention makes sure that no low data is updated under a high security context. Thus, following the transitivity of the equivalence relation, the two executions join at the postdominator with equivalent states.

One embodiment of the system of the present invention provides an encoding of confidentiality information in type annotations. The verification process is guided by some typing rules. FIG. 10 is a flow diagram of one embodiment of a process for verifying a program against its type annotations. This process delegates the task to three components, verifying the heap, the register file and the instruction sequence respectively. The program is secure with respect to a security policy only if all the three components return successfully. The process is performed by processing logic that may comprise hardware (circuitry, dedicated logic, etc.), software (such as is run on a general purpose computer system or a dedicated machine), or a combination of both.

The verification of an instruction sequence is the most complex part. Nonetheless, it is fully syntactic, thereby allowing a straightforward and mechanical implementation. Based on the syntax of the current instruction, the verification is carried out against different typing rules. The verification aborts whenever a typing rule is not satisfied, reporting a violation of confidentiality. If the typing rule is satisfied on the current instruction, the verification proceeds recursively on the remainder instruction sequence. Finally, if the end of the instruction sequence is reached (i.e., jmp or halt), processing logic terminates the verification after checking the corresponding rules.

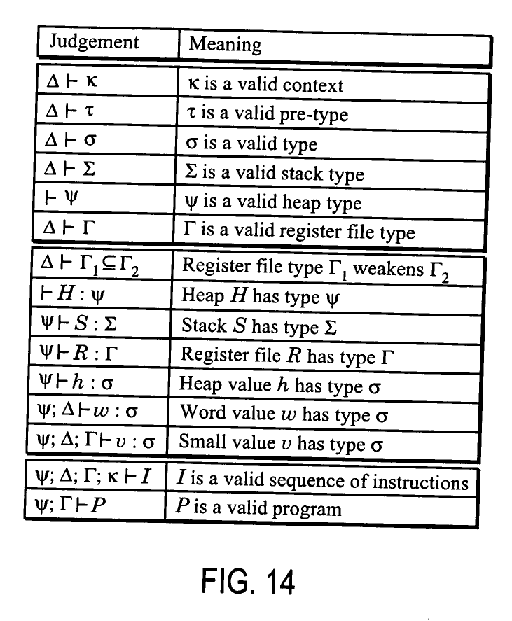

In one embodiment, the formal rules set forth in FIGS. 14, 15 and 16 are used, and explained below.

Referring to FIG. 10, the process begins by processing logic tests whether H is verifiable against Ψ (processing block 1002). If it fails, processing logic indicates the program is not acceptable (processing block 1010). If it is, processing logic tests whether R is verifiable agent (Ψ, Γ) (processing block 1003). If it is not, processing logic indicates that the program is not acceptable (processing block 1010). If it is, processing logic tests whether S is verifiable against (Ψ, Γ, κ) (processing block 1004). If it is, processing logic indicates the program is acceptable (processing block 1011).

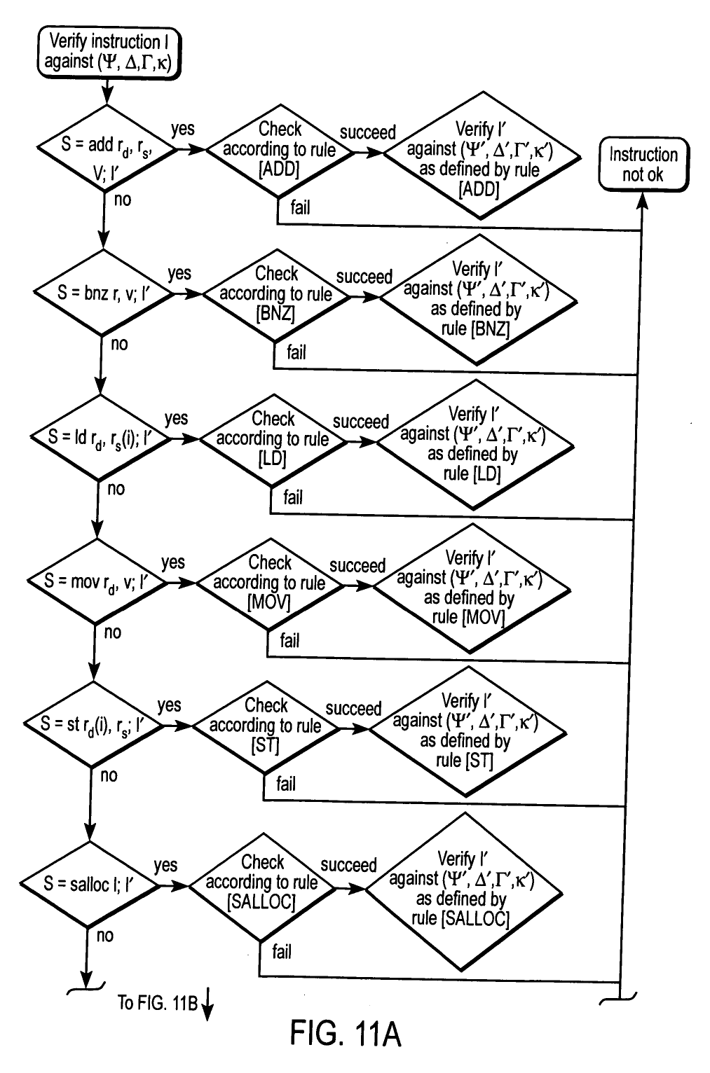

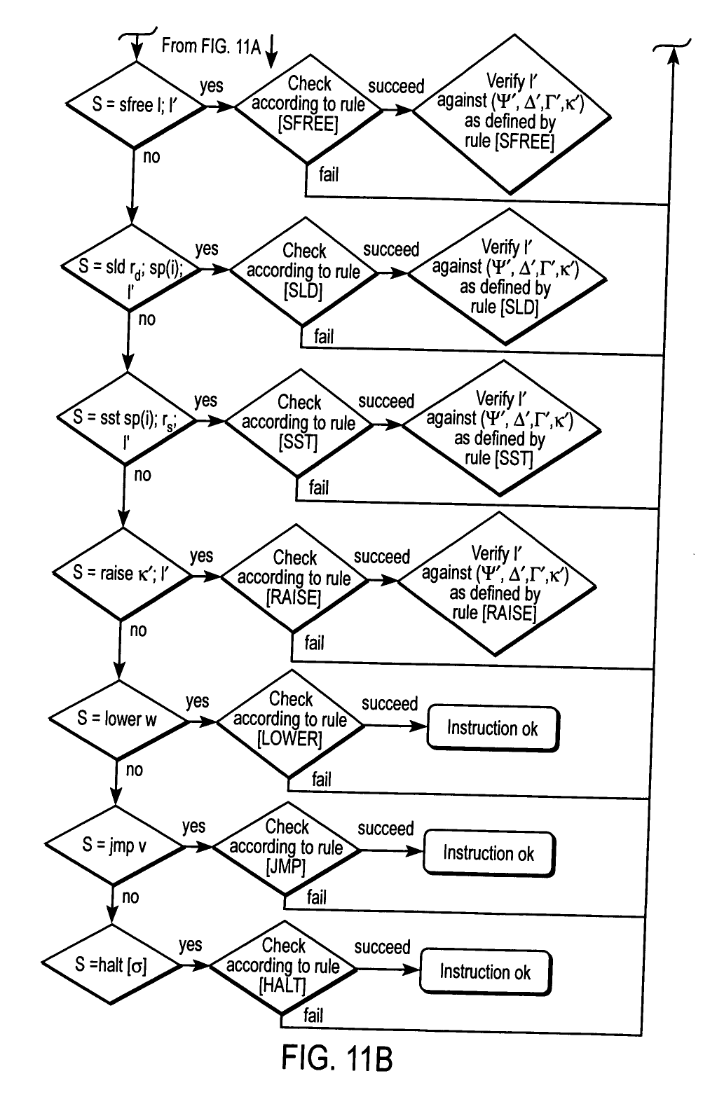

FIG. 11 illustrates an example flow diagram for verification of an instruction sequence.

Abstract Machine

In one embodiment, language TAL_{C} resembles TAL and STAL for ease of integration with existing results on conventional type safety. Some additional constructs are used for confidentiality, while some TAL and STAL features that are orthogonal to the proposed security operations are removed. Security labels are assumed to form a lattice L. The symbol θ is used to range over elements of L. The symbols ⊥ and T are used as the bottom and top of the lattice, ∪ and ∩ as the lattice join and meet operations, ⊂ as the lattice ordering. The following explains the syntactic constructs of TAL_{C}.

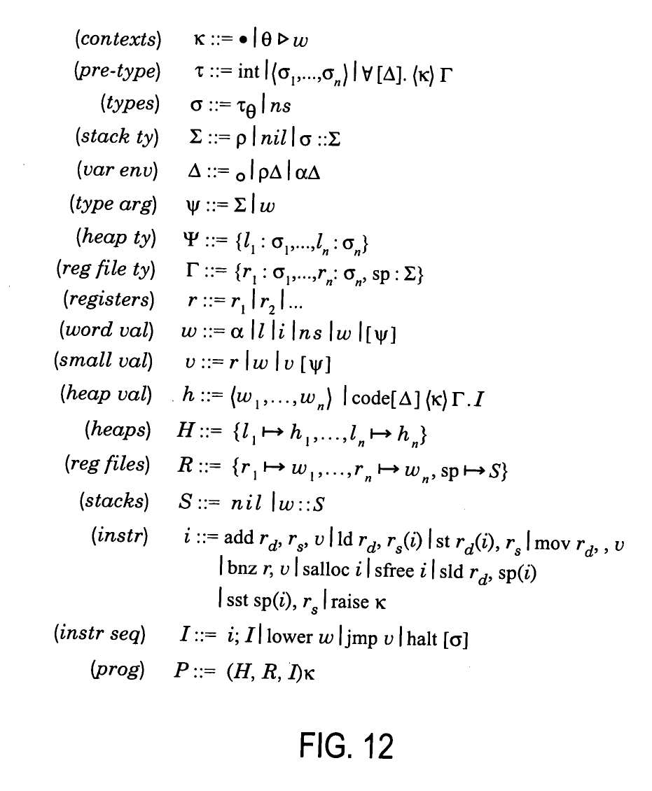

The top portion of FIG. 12 presents the type constructs. Security contexts are referred to as κ. An empty security context (•) represents an program counter with the lowest security label. A concrete context (θ [symbol] w) is made up of a security label θ (the current security level) and a postdominator w. The postdominator w has the syntax of a word value, but its use is restricted by the semantics to be eventually an instantiated code label, i.e., the ending point of the current security level. The postdominator w could also be a variable α; this is useful for compiling procedures, which can be called in different contexts with different postdominators.

Pre-types τ reflect the normal types as seen in TAL, including integer types, tuple types, and code types. In comparison with TAL, in one embodiment, the code type described herein requires an extra security context (κ) as part of the interface. A type (σ) is either a pre-type tagged with a security label or a nonsense type (ns) for uninitialized stack slots. A stack type (Σ) is either a variable (ρ), or a (possibly empty) sequence of types. The variable context (Δ) is used for typing polymorphic code; it documents stack type variables (ρ) and postdominator variables (α). Stack types and postdominators are also generally referred to herein as type arguments ψ. Finally, heap types (Ψ) or register file types (Γ) are mappings from heap labels or registers to types; the sp in the register file represents the stack.

The middle portion of FIG. 12 shows the value constructs. A word value w is either a variable, a heap label l, an immediate integer i, a nonsense value for an uninitialized stack slot, or another word value instantiated with a type argument. Small values v serve as the operands of some instructions; they are either registers r, word values w, or instantiated small values. Heap values h are either tuples or typed code sequences; they are the building blocks of the heap H. Note that a value does not carry a security label. This is consistent with the philosophy that a value is not intrinsically sensitive—it is sensitive only if it comes from a sensitive location, which is documented in the corresponding types (Ψ and Γ). Finally, a register file R stores the contents of all registers and the stack, where the stack is a (possibly empty) sequence of word values.

Code constructs are given in the bottom portion of FIG. 12. A minimal set of instructions from TAL and STAL is retained, and two new instructions (raise κ and lower l) are introduced for manipulating the security context as discussed above. In one embodiment, a program is the usual triple tagged with a security context. The security context facilitates the formal soundness proof, but does not affect the computation.

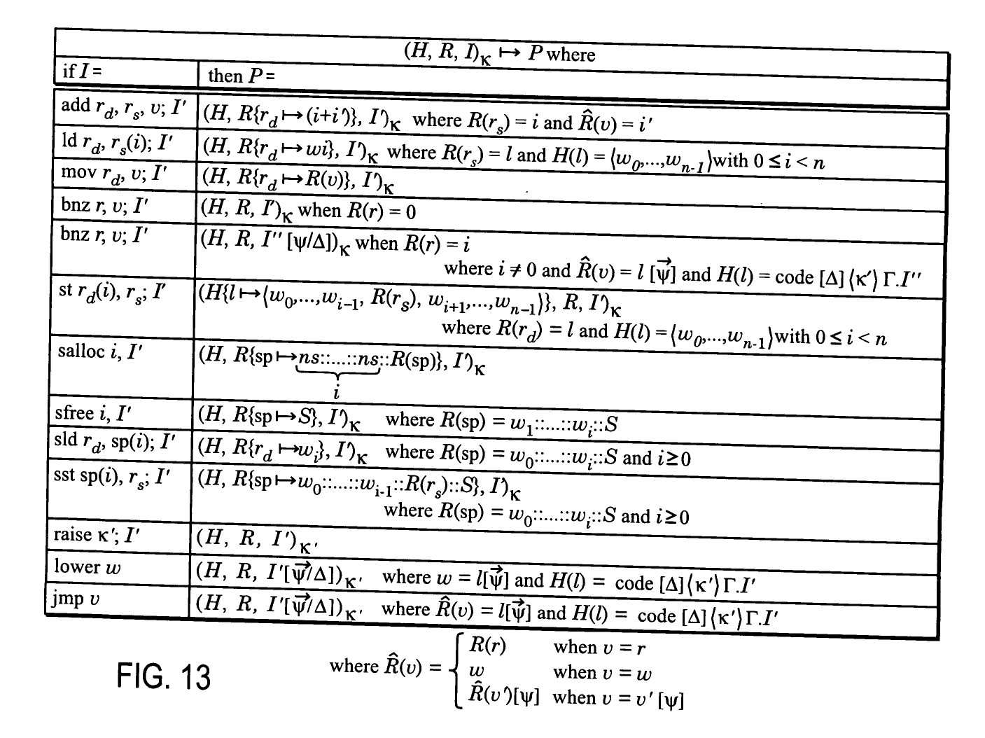

In the operational semantics (FIG. 13), there are only two cases that modify the security context: raise κ′ updates the security context to κ′, and lower w picks up a new security context from the interface of the target code w. In all other cases, the security context remains the same, and the semantics is standard. The operational semantics mimics the behavior of a real machine. One can obtain a conventional machine by removing the security contexts and raise κ instructions, and replacing lower w with jmp w.

Typing Rules

The static semantics consists of judgment forms summarized in FIG. 14. A security context appears in the judgment of a valid instruction sequence. Heap and register file types are made explicit in the judgment of a valid program for facilitating the noninterference theorem. All other judgment forms closely resemble those of TAL and STAL.

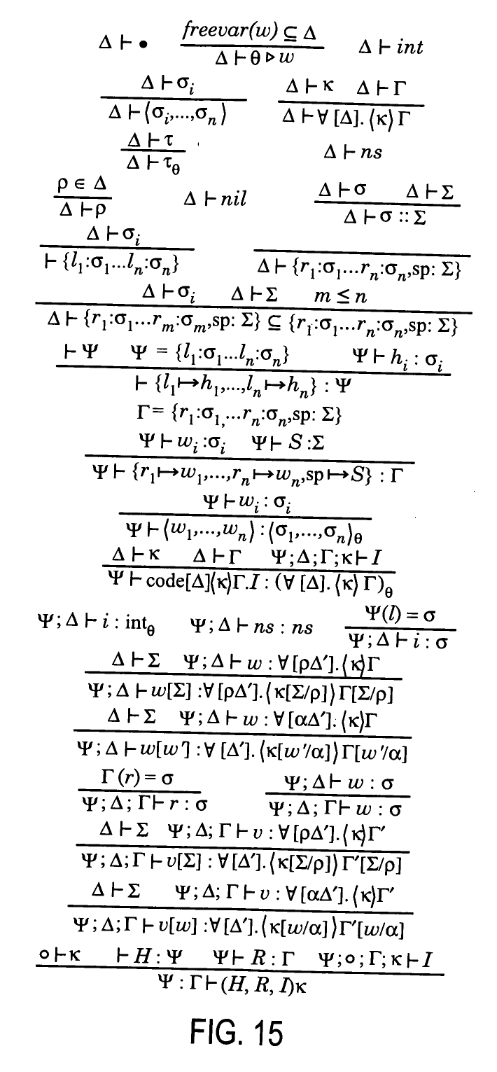

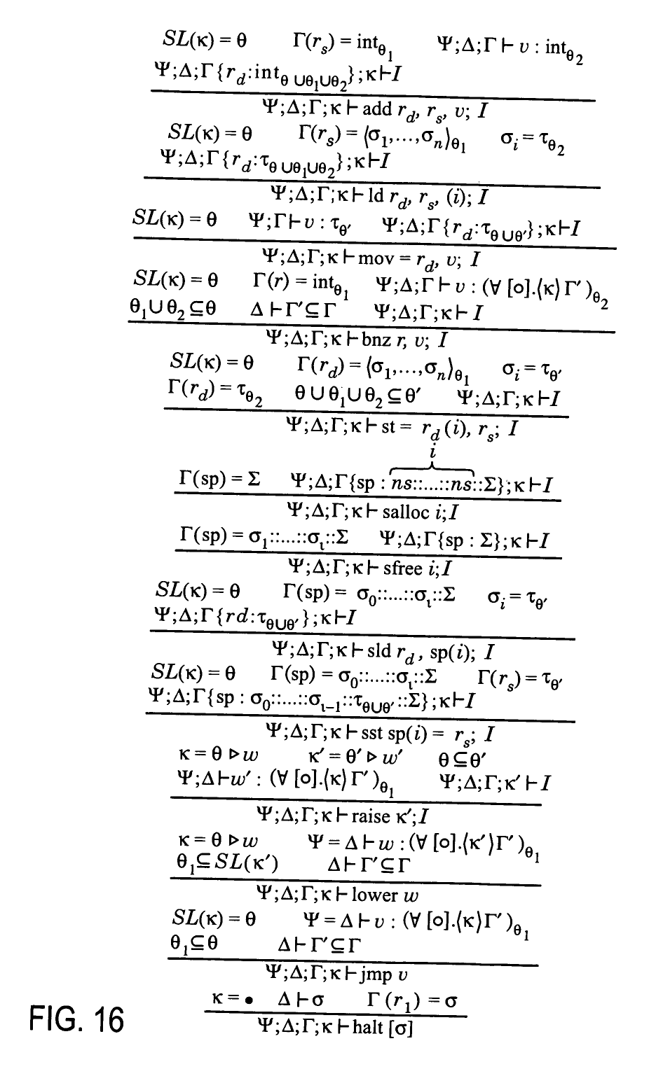

The typing rules are given in FIGS. 15 and 16. A type construct is valid (top six judgment forms in FIG. 14 if all free type variables are documented in the type environment. Heap values and integers may have any security label. The types of heap labels and registers are as described in the heap type and the register file type respectively. All other rules for non-instructions are straightforward.

In one embodiment, a macro SL(κ) is used to refer to the security label component of κ. SL(•) is defined to be ⊥. The typing rules for add, 1d and mov instructions infer the security labels for the destination registers; they take into account the security labels of the source and target operands and the current security context.

The rule for bnz first checks that the guard register r is an integer and the target value v is a code label. It then checks that the current security context is high enough to cover the security levels of the guard (preventing flows through program structures) and the target code (preventing flows through code pointers). Lastly, the checks on the register file and the remainder instruction sequence make sure that both branches are secure to execute.

The rule for st concerns four security labels. This rule ensures that the label of the target cell is higher than or equal to those of the context, the containing tuple, and the source value.

The rules for the stack instructions follow similar ideas. In essence, the stack can be viewed as an infinite number of registers. Instruction salloc or sfree add new slots to or remove existing slots from the slot, so the rules check the remainder instruction sequence under an updated stack type. The rule for instruction sld or sst can be understood following that of the mov instruction.

The rule for raise checks that the new security context is higher than the current one. Moreover, it looks at the postdominator w′ of the new context, and makes sure that the security context at w′ matches the current one. The remainder instruction sequence is checked under the new context.

Since the rule for raise already checked the validity of the ending label of a secured region, the task for ending the region is relatively simple. The rule for lower checks that its operand label matches that dictated by the security context. This guarantees that a secured region be enclosed within a raise-lower pair. The rule also makes sure that the code at w is safe to execute, which involves checking the security labels and the register file types.

The rule for jmp checks that the target code is safe to execute. Similar checks also appeared in the rule for bnz. In these two rules, the security context of the target code is the same as the current one. This is because context changes are separated from conventional instructions in one embodiment of the system. For example, one may enclose high target code within raise and lower before calling it in a low context.

Finally, halting is valid only if the security context is empty, and the value in rᵢ has the expected type σ.

The TAL_{C} language enjoys conventional type safety (memory and control flow safety), which can be established following the progress and preservation lemmas. The proofs of these lemmas are similar to those of TAL and STAL and have been omitted to avoid obscuring the present invention.

Lemma 1 (Progress): If Ψ; Γ [symbol] P then either:
1. there exists P′ such that P [symbol] P′, or
2. P is of the form (H, R{r₁ [symbol] w}, halt [σ])• where [symbol] H: Ψ and Ψ;° [symbol] w: σ.

Lemma 2 (Preservation): If Ψ; Γ [symbol] P and P [symbol] P′, then there exists Γ′ such that Ψ; Γ′ [symbol] P′.

Before presenting the noninterference theorem for TAL_{C}, the equivalence of two programs is defined with respect to a given security level θ.

Definition 1 (Heap Equivalence): Ψ [symbol] H₁≈_{θ}H₂ [symbol] for every l ε dom(Ψ),
Ψ(l)=τ_{θ′} and θ′⊂θ implies H₁(l)=H₂(l).

Definition 2 (Stack Equivalence): Σ [symbol] S₁≈_{θ}S₂ [symbol] for every stack slot i ε dom(Σ),
Σ(i)=τ_{θ′} and θ′⊂θ implies S₁(i)=S₂(i).

Definition 3 (Register File Equivalence): Γ [symbol] R₁≈_{θ}R₂ [symbol] both
1. Γ(sp) [symbol] R₁(sp)≈_{θ}R₂(sp), and
2. for every r ε dom(Γ), Γ(r)=τ_{θ′} and θ′⊂θ implies R₁(r)=R₂(r).

Definition 4 (Program Equivalence): Ψ; Γ [symbol] P₁≈_{θ}P₂ [symbol] P₁=(H₁, R₁, I₁)_{κ}_{₁},
P₂=(H₂,R₂,I₂)_{κ2}, Ψ [symbol] H₁≈_{θ}H₂, Ψ; Γ [symbol] R₁≈_{θ}R₂, and either:
1. κ₁=κ₂, SL(κ₁)⊂θ, and I₁=I₂, or
2. SL(κ₁)⊂θ, SL(κ2)⊂θ.

The above three relations are all reflexive, symmetrical, and transitive. The noninterference theorem relates the executions of two equivalent programs that both start in a low security context (relative to the security level of concern). If both executions terminate, then the result programs must also be equivalent.

The basic idea of the proof is intuitive. Based on the security context of the programs and the security level of concern, the executions can be phased into “low steps” and “high steps.” The two executions under a low step can be related, because they are executing the same instructions. Reasoning under a high step is different—the two executions are no longer in lock step. However, the raise and lower mark the beginning and end of a secured region, and therefore the program states are related before the raise and after the lower, hence circumvent directly relating two executions in a high step. Additional formal details with three lemmas and a noninterference theorem are provided. Lemma 3 indicates that a security context in a high step can be changed only with raise or lower. Lemma 4 states that a terminating program is to reduce to a step that discharges the current security context with a lower. Lemma 5 articulates the lock step relation between two equivalent programs in a low step. Theorem 1 then follows from these lemmas.

In the following, [symbol] *represents the reflexive and transitive closure of [symbol] ·Σ≧_{θ}Σ′ means that Σ(i)=Σ′(i) for every i such that Σ′(i)=τ_{θ′} and θ′⊂θ. Γ≧_{θ}Γ′ means that Γ(sp)≧_{θ}Γ′(sp) and Γ(r)=Γ′(r) for every r such that Γ′(r)=τ_{θ′} and θ′⊂θ. The symbol Q is used in addition to P to denote programs when comparing two executions.

Lemma 3 (High Step): If P=(H, R, I)_{κ}, SL(κ)⊂θ, Ψ; Γ [symbol] P, then either:
1. there exists Γ₁ and P₁=(H₁, R₁, I₁)_{κ}, K such that P [symbol] P₁, Ψ; Γ₁ [symbol] P₁, Γ≧_{θ}Γ₁, and Ψ; Γ₁ [symbol] P≈_{θ}P₁, or
2. I is of the form (raise κ′; I′) or (lower w).

Proof sketch: By case analysis on the first instruction of I. I cannot be halt, because the typing rule for halt requires the context to be empty. If I is not halt, raise or lower, by the operational semantics and inversion on the typing rules, one can find Γ₁ and P₁ for the next step. The typing rules prohibits writing into a low heap cell, hence low heap cells remain the same after the step. When a register is updated, Γ₁ gives it an updated type whose security label takes SL(κ) into account, hence that register or stack slot has a high type in Γ₁. As a result, Γ≧_{θ}Γ₁, and Ψ; Γ₁ [symbol] P≈_{θ}P₁.

Lemma 4 (Context Discharge): If P=(H, R, I)_{θw}, θ⊂θ′, Ψ; Γ [symbol] P, P [symbol] *(H₀, R₀, halt [σ])•, then there exists Γ′ and P′=(H′, R′, lower w)_{θw} such that Ψ; Γ′ [symbol] P′, P [symbol] *P′, Γ≧_{θ′}Γ′, and Ψ; Γ′ [symbol] P≈_{θ}P′.

Proof sketch: By generalized induction on the number of steps of the derivation P [symbol] *(H₀, R₀, halt [σ])•

The base step of zero step is not possible, because the security contexts do not match. In the inductive case, suppose the execution consists of n steps, and the proposition holds for any step number less than n. There are two cases to consider, following Lemma 3.

In the case where the first instruction of l is not raise or lower, by Lemma 3, there exists Γ₁ and P₁ such that P [symbol] P₁, Ψ; Γ₁ [symbol] P₁, Γ≧_{θ′}Γ₁, Ψ; Γ₁ [symbol] P≈_{θ′}P₁, and the security context of P₁ is the same as that of P. Note that P₁ is a step in between P and the final program (H₀, R₀, halt [σ])• because the operational semantics is deterministic. Hence by induction hypothesis on P₁, there exists Γ′ and P′ such that Ψ; Γ′ [symbol] P′, P₁ [symbol] *P′, Γ₁≧_{θ′}Γ′, and Ψ; Γ′ [symbol] P₁≈_{θ′}P′. Putting the above together, P [symbol] *P′, Γ≧_{θ′}Γ′ because ≧_{θ′} is transitive by definition, and Ψ; Γ′ [symbol] P≈_{θ′}P′ by definition and the fact that Γ₁≧_{θ′}Γ′.

Case I=raise θ₁ [symbol] wₜ; I₁. By definition of the operational semantics, P [symbol] P₁ where P₁=(H, R, I₁)_{θ}_{₁}_{w}_{₁}. By inversion on Ψ; Γ [symbol] P and the typing rule of raise, θ⊂θ₁ and Ψ; Γ; θ₁ [symbol] w₁ [symbol] I₁. By definition of well-typed programs, Ψ; Γ [symbol] P₁. By induction hypothesis on P₁, there exists Γ₂ and P₂=(H₂, R₂, lower W₁)_{θ}_{₁}_{w}_{₁} such that Ψ; Γ₂ [symbol] P₂, P₁ [symbol] *P₂, Γ≧_{θ′}Γ₂ and Ψ; Γ₂ [symbol] P₁≈_{θ′}P₂. Ψ; Γ₂ [symbol] P≈_{θ′}P₂ then follows because the heap and register file remains the same in P and P₁.

Furthermore, by the operational semantics, P₂ [symbol] P₃ where P₃=(H₂, R₂, I₃)_{κ} and I₃ is the instantiated code of w₁ whose security context is κ. By inversion on the well-typedness of I(i.e., raise θ₁ [symbol] w₁; I₁), κ=θ [symbol] w. By induction hypothesis on P₃, there exists Γ′ and P′=(H′, R′, lower w)_{θw} such that Ψ; Γ′ [symbol] P′, P₃ [symbol] *P′, Γ₂≧_{θ′}Γ′, and Ψ; Γ′ [symbol] P₃≈_{θ′}P′. Putting the above together, the original proposition holds for case I=raise θ₁ [symbol] w₁;I₁.

Case S=lower w₁. By inversion on the typing rule of lower, w=w₁. Let P′=P, the proposition holds.

Lemma 5 (Low Step): If P=(H, R, I)_{κ}, SL(κ)⊂θ, Ψ; Γ [symbol] P, Ψ, Γ [symbol] Q, Ψ; Γ [symbol] P≈_{θ}Q, P [symbol] P₁, Q [symbol] Q₁, then exists Γ₁ such that Ψ; Γ [symbol] P₁, Ψ; Γ [symbol] Q₁, and Ψ; Γ₁ [symbol] P₁≈_{θ}Q₁.

Proof sketch: By case analysis on the first instruction of I. Since SL(κ)⊂θ, P and Q contains the same instruction sequence by definition of ≈_{θ}. The case of raising to a higher context does not change the state, thereby trivially maintaining the equivalence. All other cases maintain that the security context is lower than θ. Inspection on the typing derivation shows that low locations in the heap can only be assigned low values. Once a register is given a high value, its type in Γ₁ will change to high. In the case of branching, the guard must be low, so both P and Q branch to the same code. Hence the two programs remain equivalent after one step.

Theorem 1 (Noninterference): If P=(H, R, I)_{κ}, SL(κ)⊂θ′, Ψ; Γ [symbol] P, Ψ; Γ [symbol] Q, Ψ; Γ [symbol] P≈_{θ}Q, P [symbol] *(Hₚ, Rₚ, halt [σₚ])•, and Q [symbol] *(H_{q}, R_{q}, halt [σ_{q}])•, then exists Γ′ such that Ψ; Γ′ [symbol] (Hₚ, Rₚ, halt [σₚ])•≈_{θ}(H_{q}, R_{q}, halt [σ_{q}])•

Proof sketch: By generalized induction on the number of steps of the derivation P [symbol] *(Hₚ, Rₚ, halt [σₚ])•. The base case of zero step is trivial. The inductive case is done by case analysis on the first instruction of I.

Consider the case where I is of the form raise θ₁ [symbol] w₁; I₁ where θ₁⊂θ. By definition of the operational semantics and the typing rules, P [symbol] P₁ where=P₁=(H, R, I₁)_{θ}_{₁}_{w}_{₁} and Ψ; Γ [symbol] P₁. By Lemma 4, there exists Γ₂ and P₂=(H₂, R₂, lower w₁)_{θ}_{₁}_{w}_{₁} such that Ψ; ⊖₂ [symbol] P₂, P₁ [symbol] *P₂, Γ≧_{θ}Γ₂, and Ψ; Γ₂ [symbol] P₁≈θP₂. Hence Ψ; [symbol] H≈_{θ}H₂ and Ψ; Γ₂ [symbol] R≈_{θ}R₂.

By the operational semantics, P₂ [symbol] P₃ where w₁=l₁[\vec{ψ}]P₃=(H₂, R₂, I₃[\vec{ψ}/Δ])_{κ3} and H(l₁)=code[Δ](κ₃)Γ₃. I₃. By inversion on the typing derivation of Ψ; Γ₂ [symbol] P₂, Γ₃⊂Γ₂ and Ψ; Γ₃ [symbol] P₃. it follows that Ψ; Γ₃ [symbol] R≈_{θ}R₂. By inversion on the typing derivation of Ψ; Γ [symbol] P where the first instruction of P is raise θ₁ [symbol] w₁I; I₁, κ₃=κ.

By similarly reasoning, Q [symbol] *Q₃ where Q₃=(H+₂, R′₂, I₃)_{κ3}, Ψ [symbol] H≈_{θ}H′₂, Ψ; Γ₃ [symbol] R≈_{θ}R′₂ and Ψ; Γ₃ [symbol] Q₃. By transitivity of the equivalence relations, Ψ [symbol] H₂≈_{θ}H′₂ and Ψ; Γ₃ [symbol] R₂≈_{θ}R′₂. Hence Ψ; Γ [symbol] P₃≈_{θ}Q₃. The case then follows by induction hypothesis.

All other cases remain low after a step. By Lemma 5, the two executions in the next step are equivalent and well typed. The proof of these cases then follows by induction hypothesis.

Certifying Compilation for Confidentiality

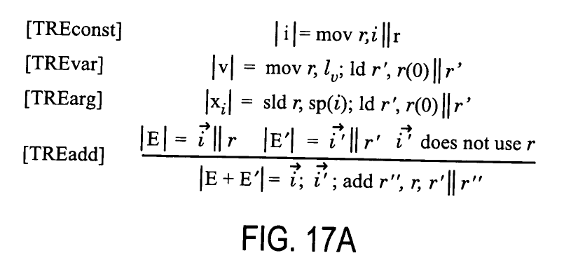

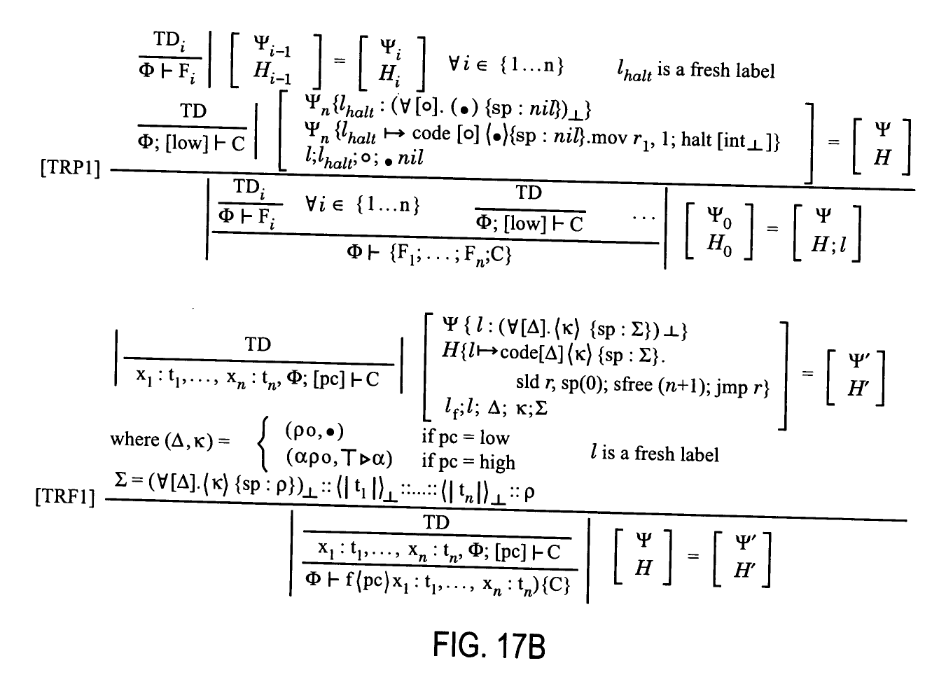

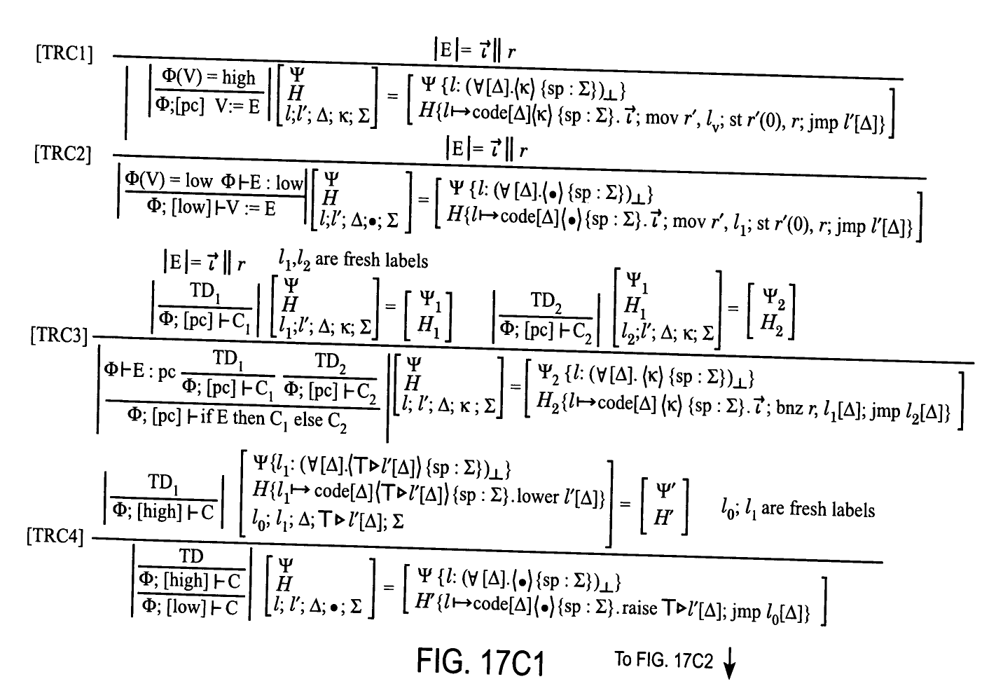

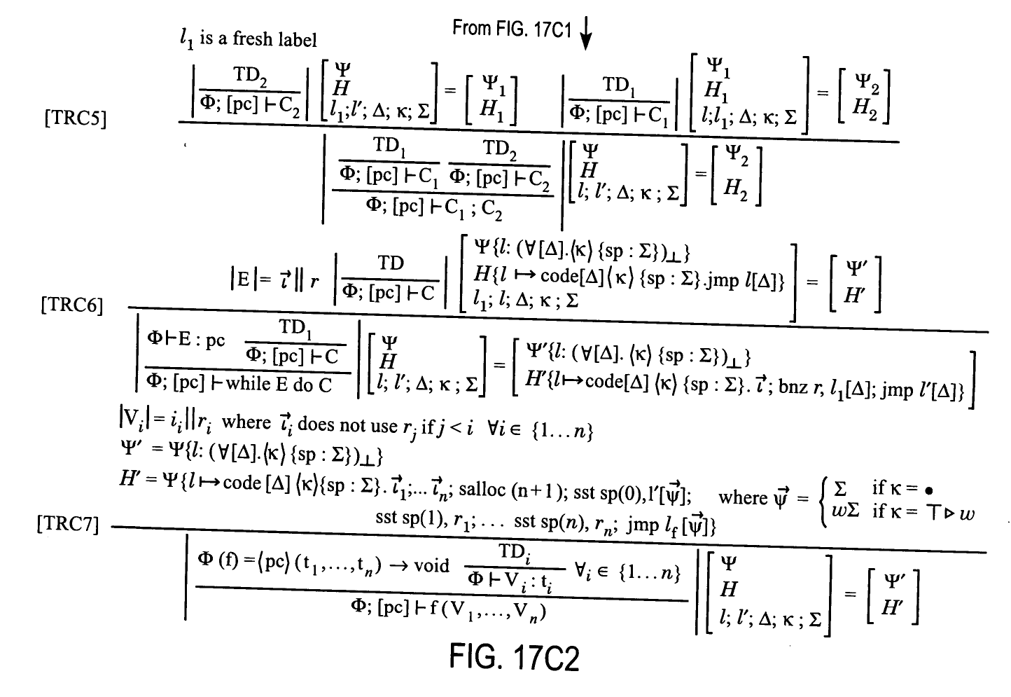

The noninterference theorem described above guarantees that well-typed TAL_{C} programs satisfy the information flow policy, even in the presence of memory aliasing and first-class code pointers. The following describes how TAL_{C} may serve as the target of certifying compilation (FIGS. 17A, 17B and 17C).

Certifying compilation for a realistic language typically involves a complex sequence of transformations, including CPS and closure conversion, heap allocation, and code generation. A simple security-type system of FIG. 2 is chosen as a source language. This allows a concise presentation, yet suffices in demonstrating the separation of security-context operations raise and lower from conventional instructions and mechanisms (e.g., stack convention for procedure calls).

The low-high security hierarchy of FIG. 2 defines a simple lattice consisting of two elements: ⊥ and T. In the following, |t| is used to denote the translation of source type t in TAL_{C}: |low|≡int _{⊥} and |high|≡int_{T}. The procedure types are also translated from the source language into TAL_{C} as follows:

$$\vert 〈 pc 〉 ( {t}_{1} , … , {t}_{n} ) \to void \vert = ( ∀ [ Δ ] \cdot 〈 κ 〉 \{ sp \text{:} \sum \} ) ⊥ where ( Δ , κ ) = \{ \begin{matrix}( ρ o , • ) & if pc = low \\ ( α ρ o , ⊤ ⊳ α ) & if p c = high\end{matrix} \\ and \sum = ( ∀ [ Δ ] \cdot 〈 κ 〉 \{ sp \text{:} ρ \} ) ⊥ ∷ 〈 \vert {t}_{1} \vert 〉 ⊥ ∷ … ∷ 〈 \vert {t}_{n} \vert 〉 ⊥ ∷ ρ$$

This procedure type translation assumes a calling convention where the caller pushes a return pointer and the location of the arguments (implementing the call-by-reference semantics of the source language) onto the stack, and the callee deallocates the current stack frame upon return. The stack type Σ refers to a variable ρ because the procedure may be called under different stacks, as long as the current stack frame is as expected. The security context κ is empty if pc is low, or T [symbol] α if pc is high. Postdominator variable α is used because the procedure may be called in security contexts with different postdominators. The type environment Δ simply collects all the needed type variables.

The program translation starts in a heap H₀ and a heap type Ψ₀ which satisfy [symbol] H₀:Ψ₀ and contain entries for all the variables and procedures of the source program. For any source variable ν that Φ(ν)=t, there exists a location lᵥ in the heap such that Ψ₀(l_{ν})=<|t|>_{⊥}. For any source procedure f that, Φ(f)=<pc>(t₁, . . . , tₙ)→void, there exists a location l_{f} in the heap such that Ψ₀(l_{f})=|<pc>(t₁, . . . , tₙ)→void |. Φ˜Ψ₀ is used to refer to this correspondence.

In one embodiment, the above heap Ψ₀ can be constructed with dummy slots for the procedures—the code in there simply jumps to itself. This suffices for typing the initial heap, thus facilitating the type-preservation proof. It creates locations for all source procedures and allows the translation of the actual code to refer to them.

The translation details are given in FIGS. 17A, 17B and 17C, based on the structure of the typing derivation of the source program. Which translation rule to apply is determined by the last typing rule used to check the source construct (program, procedure, or command). We use TD to denote (possibly multiple) typing derivations.

An expression translation of the form |E|=\vec{t}∥ν is defined in FIG. 17A. The instruction vector \vec{t} computes the value of E and the result is put in the register r. For a global variable, the value is loaded from the heap using its corresponding heap label. For a procedure argument, the location of the actual entity is loaded from the stack, and the value is then loaded from the heap.

In FIG. 17B, when translating a program (Rule [TRP1]), all the procedure declarations are translated, add halting code as the ending point of the program, and proceed to translate the main command. The result triple contains the updated heap type and heap, and a starting label l which leads to the starting point of the program. Procedure translation (Rule [TRF1]) takes care of part of the calling convention. It adds epilogue code that loads the return pointer, deallocates the current stack frame and transfers the control to the return pointer. It then resorts to command translation to translate the procedure body, providing the label to the epilogue code as the ending point of the procedure body.

FIG. 17C define command translation of the form

$$\vert \frac{TD}{[ pc ] ⊢ C} \vert [ \begin{matrix}Ψ \\ H \\ {l}_{start} ; {l}_{end} ; Δ ; κ ; \sum \end{matrix} ] = [ \begin{matrix}{Ψ}^{′} \\ {H}^{′}\end{matrix} ] .$$

This command translation takes 7 arguments: a code heap type (Ψ), a code heap (H), starting and ending labels (lₛₜₐᵣₜ and l_{end}) for the computation of C, a type environment (Δ), a security context (κ), and a stack type (Σ). It generates the extended code heap type (Ψ′) and code heap (H′). Unsurprisingly, this translation appears complex, because it provides a formal model of a certifying compiler. Nonetheless, it is easy to follow if some invariants maintained by the translation are remembered:

H is well-typed under Ψ and contains entries for all source variables and procedures;

Ψ and H already contain the continuation code labeled l_{end};

The new code labeled lₛₜₐᵣₜ will be put in Ψ′ and H′;

The security context κ must match pc;

The stack type Σ contains entries for all procedure arguments, if the command being compiled is in the body of a procedure;

The environment Δ contains all free type variables in κ and Σ.

Most of the command translation rules simply put Δ, κ and Σ in place for the generated code types, and further propagate them to the translation of sub-components. The only rule that non-trivially manipulates the security context is Rule [TRC4]—when a subsumption rule is used for typing a source command, the translation generates code that is enclosed in a raise-lower pair. The translation of the sub-component is carried out in an updated heap with a new ending label l₁. The code at l₁ restores the security context and transfers the control to the given ending label l′. After the translation of the sub-component, code is added at the starting label l to raise the security context to the expected level.

Procedure call translation is given as Rule [TRC7]. It creates “prologue” code that allocates a stack frame, pushes the return pointer and the arguments onto the stack, and jumps to the procedure label. Note that the corresponding epilogue code is generated by the procedure declaration translation in Rule [TRF1].

The translation of while-loops is also interesting (Rule [TRC6]). When translating the loop body, the continuation block needs to be prepared, which happens to be the code for the loop test. A dummy block labeled l is used to serve as the continuation block when translating the body C. This block is introduced for maintaining the above invariants. It facilitates the type-preservation proof of the translation. After the translation of the loop body, this dummy block is replaced with the actual code that implements the loop test, as shown on the bottom right side of Rule [TRC6].

Lemma 6 (Expression Translation) If Φ˜Ψ, Φ [symbol] E:t, |E|=\vec{i}∥r, and Ψ; {r: |t|, sp: Σ}; κ [symbol] I, then Ψ; Δ; {sp:Σ}; κ [symbol] \vec{i}I.

Lemma 7 (Command Translation)

$$If Φ \sim Ψ , Φ ; [ pc ] ⊢ C , \vert \frac{TD}{Φ ; [ pc ] ⊢ C} \vert [ \begin{matrix}Ψ \\ H \\ {l}_{start} ; {l}_{end} ; Δ ; κ ; \sum \end{matrix} ] = [ \begin{matrix}{Ψ}^{′} \\ {H}^{′}\end{matrix} ] . Ψ ( {l}_{end} ) = ( ∀ [ Δ ] \cdot 〈 κ 〉 \{ sp \text{:} \sum \} ) ⊥ , SL ( κ ) = \vert pc \vert , ⊢ H \text{:} Ψ , then Φ ∼ {Ψ}^{′} , ⊢ {H}^{′} \text{:} {Ψ}^{′} and {Ψ}^{′} ; Δ ⊢ {l}_{start} \text{:} ( ∀ [ Δ ] \cdot 〈 κ 〉 \{ sp \text{:} \sum \} ) ⊥ .$$

The proofs for the above two lemmas are straightforward by structural induction on the derivation of the translation. Type preservation of procedure translation can be derived from Lemma 7 based on Rule [TRF1]. Type preservation of program translation then follows based on Rule [TRP1].

Lemma 8 (Procedure Translation)

$$If Φ \sim Ψ , Φ ⊢ F , ⊢ H \text{:} Ψ , \vert \frac{TD}{Φ ⊢ F} \vert [ \begin{matrix}Ψ \\ H\end{matrix} ] = [ \begin{matrix}{Ψ}^{′} \\ {H}^{′}\end{matrix} ] , then Φ \sim {Ψ}^{′} and ⊢ {H}^{′} \text{:} {Ψ}^{′} .$$

Theorem 2 (Program Translation)

$$If Φ \sim {Ψ}_{0} , Φ ⊢ P , ⊢ {H}_{0} \text{:} {Ψ}_{0} , \vert \frac{TD}{Φ ⊢ P} \vert [ \begin{matrix}{Ψ}_{0} \\ {H}_{0}\end{matrix} ] = [ \begin{matrix}Ψ \\ H ; l\end{matrix} ] , then Φ \sim Ψ and Ψ ; \{ sp \text{:} nil \} ⊢ ( H , \{ sp \text{:} nil \} , jmp l ) • .$$

Extensions and Alternatives

Orthogonal Features: In the above discussions, TAL_{C} focuses on a minimal set of language features. In alternative embodiments, polymorphic and existential types, as seen in TAL, are orthogonal and can be introduced with little difficulty. Furthermore, since TAL_{C} is compatible with TAL, it is also possible to accommodate other features of the TAL family. For instance, alias types may provide a more accurate alias analysis, improving the current conservative approach that considers every pointer as a potential alias. In the following, we will also discuss the use of singleton types.

Security Polymorphism: TAL_{C} relies on a security context θ [symbol] w to identify the current security level θ and its ending point w. It is monomorphic with respect to security, because the security context of a code block is fixed. In practice, security-polymorphic code can also be useful.

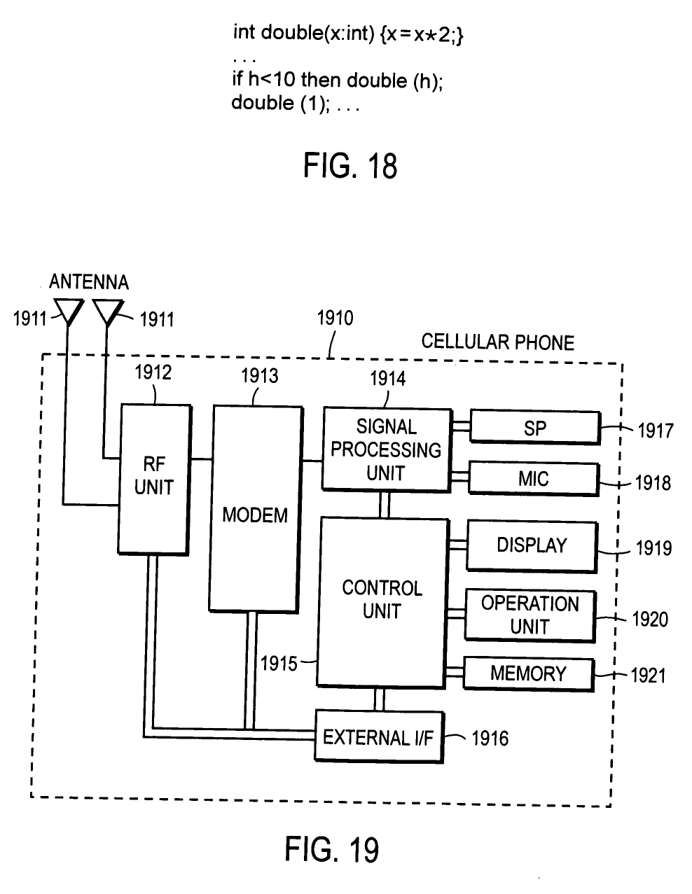

FIG. 18 gives an example. The function double can be invoked with either low or high input. It is safe to invoke double in a context if only the security level of the input matches that of the context. In a polymorphic TAL_{C}-like type system, double can be given the type (∀[θ,α].<θ [symbol] α>{r₁: int_{θ},r₀:(∀[].<θ [symbol] α>{r₁:int_{θ}})_{™}})_{⊥}. In this case, r₁ is the argument register, r₀ stores the return pointer, and meta-variables θ is reused as a variable.

It is straightforward to support this kind of polymorphism. In fact, most of the required constructs are already present in TAL_{C}. We omitted such polymorphism simply because it complicates the presentation without providing additional insights. Nonetheless, the expressiveness of such polymorphism is still limited. Since the label cc is not known until instantiated, the code of double has no knowledge about a. Hence the security context θ [symbol] α cannot be discharged within the body of double.

It is not obvious why one would wish to discharging the security context within a polymorphic function. Indeed, it is always possible to wrap a function call inside a secured region by symmetric raise and lower operations from the caller's side. However, the asymmetric discharging of security context may sometimes be desirable for certifying optimization. For instance, in FIG. 18, double is called as the last statement of the body of a high conditional. In this case, directly discharging the security context when double returns would remove a superfluous lower operation from the caller's side. Such a discharging requires lower to operate on small values (in particular, registers)—since the return label is not static, it is passed in through a register.

It may require singleton types and intersection types to support such a powerful lower operation. For example, a double function that automatically discharges its security context can have the type

$${( ∀ [ θ , α ] \cdot 〈 θ ⊳ α 〉 \{ \begin{matrix}{r}_{1} : {int}_{θ} , \\ {r}_{0} : sin t ( α ) ⊥ ⋀ ( ∀ • \cdot 〈 • 〉 \{ {r}_{1} \text{:} {int}_{θ} \} ) ⊥\end{matrix} \} )}_{⊥} .$$

At the end of the function, an instruction lower r₀ discharges the security context and transfers the control to the return code. For type checking, the singleton integer type sin t(α) matches the register r₀ with the label in the security context, and the code type ensures that the control flow to the return code is safe.

Full erasure: With the powerful type constructs discussed above, one can achieve a full erasure for the lower operation. Instead of treating lower as an instruction, one can treat it s a transformation on small values. This is in spirit similar to the pack operation of existential types in TAL. Such a lower transformation bridges the gap between the current security context and the security level of the target label. The actual control flow transfer is then completed with a conventional jump instruction (e.g., jmp (lower r₀)). One can also achieve a full erasure for lower even without dependent types. The idea is to separate the jump instruction into direct jump and indirect jump. This is also consistent with real machine architectures. The lower operation, similar to pack, transforms word values (eventually, direct labels). Lowered labels, similar to packed values, may serve as the operand of direct jump. Indirect jump, on the other hand, takes normal small values. This is expressive enough for certifying compilation, yet may not be sufficient for certifying optimization as discussed above.

An Exemplary Mobile Phone

FIG. 19 is a block diagram of one embodiment of a cellular phone. Referring to FIG. 19, the cellular phone 1910 includes an antenna 1911, a radio-frequency transceiver (an RF unit) 1912, a modem 1913, a signal processing unit 1914, a control unit 1915, an external interface unit (external I/F) 1916, a speaker (SP) 1917, a microphone (MIC) 1918, a display unit 1919, an operation unit 1920 and a memory 1921. These components and their operation are well-known in the art.

In one embodiment, control unit 1915 includes a CPU (Central Processing Unit), which cooperates with memory 1921 to perform the operations described above.

An Exemplary Computer System

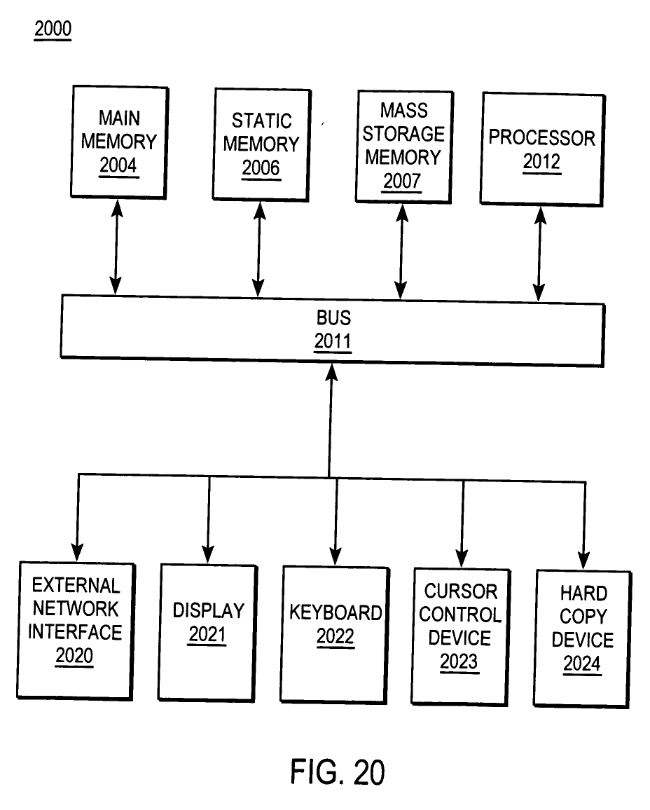

FIG. 20 is a block diagram of an exemplary computer system that may perform one or more of the operations described herein. Referring to FIG. 20, computer system 2000 may comprise an exemplary client or server computer system. Such a client may be part of another device, such as a mobile device.

Computer system 2000 comprises a communication mechanism or bus 2011 for communicating information, and a processor 2012 coupled with bus 2011 for processing information. Processor 2012 includes a microprocessor, but is not limited to a microprocessor, such as, for example, Pentium™, PowerPC™, etc.

System 2000 further comprises a random access memory (RAM), or other dynamic storage device 2004 (referred to as main memory) coupled to bus 2011 for storing information and instructions to be executed by processor 2012. Main memory 2004 also may be used for storing temporary variables or other intermediate information during execution of instructions by processor 2012.

Computer system 2000 also comprises a read only memory (ROM) and/or other static storage device 2006 coupled to bus 2011 for storing static information and instructions for processor 2012, and a data storage device 2007, such as a magnetic disk or optical disk and its corresponding disk drive. Data storage device 2007 is coupled to bus 2011 for storing information and instructions.

Computer system 2000 may further be coupled to a display device 2021, such as a cathode ray tube (CRT) or liquid crystal display (LCD), coupled to bus 2011 for displaying information to a computer user. An alphanumeric input device 2022, including alphanumeric and other keys, may also be coupled to bus 2011 for communicating information and command selections to processor 2012. An additional user input device is cursor control 2023, such as a mouse, trackball, trackpad, stylus, or cursor direction keys, coupled to bus 2011 for communicating direction information and command selections to processor 2012, and for controlling cursor movement on display 2021.

Another device that may be coupled to bus 2011 is hard copy device 2024, which may be used for marking information on a medium such as paper, film, or similar types of media. Another device that may be coupled to bus 2011 is a wired/wireless communication capability 2025 to communication to a phone or handheld palm device. Note that any or all of the components of system 2000 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving securely typed native code;
performing verification with respect to information flow for the securely typed native code based on a security policy.

2. The method defined in claim 1 wherein the securely typed native code comprises assembly code having annotations.

3. The method defined in claim 2 wherein the annotations comprise operations to mark a beginning and an ending of a region of the code in which two execution paths based on predetermined information are encountered.

4. The method defined in claim 2 further comprising:
removing the annotations from the code; and
running the code if performing verification determines the code does not violate the security policy.

5. The method defined in claim 1 wherein performing verification occurs on a device prior to the device running the code.

6. The method defined in claim 1 wherein performing verification comprises statically checking behavior of the code to determine whether the code does not violate the security policy.

7. The method defined in claim 6 wherein the code does not violate the security policy if the code, when executed, would not cause information of an identified type to flow from a device executing the code.

8. The method defined in claim 1 further comprising running the code if performing verification determines the code does not violate the security policy.

9. The method defined in claim 1 wherein receiving the code comprises downloading the code.

10. The method defined in claim 1 wherein receiving securely typed native code comprises receiving assembly code that has undergone a security-type preserving translation that includes annotating the assembly code with type information, and further wherein performing verification comprises verifying the type information by statically checking, with respect to a safety policy, information flow that would occur under control of the assembly code when executed.

11. An article of manufacture having one or more recordable media storing instructions thereon which, when executed by a system, causes the system to perform a method comprising:
receiving securely typed native code;
performing verification with respect to information flow for the securely typed native code based on a security policy.

12. The article of manufacture defined in claim 11 wherein the securely typed native code comprises assembly code having annotations.

13. The article of manufacture defined in claim 12 wherein the annotations comprise operations to mark a beginning and an ending of a region of the code in which two execution paths based on predetermined information are encountered.

14. The article of manufacture defined in claim 12 wherein the method further comprises:
removing the annotations from the code; and
running the code if performing verification determines the code does not violate the security policy.

15. The article of manufacture defined in claim 11 wherein performing verification comprises statically checking behavior of the code to determine whether the code does not violate the security policy.

16. The article of manufacture defined in claim 14 wherein the code does not violate the security policy if the code, when executed, would not cause information of an identified type to flow from a device executing the code.

17. The article of manufacture defined in claim 11 wherein the method further comprises running the code if performing verification determines the code does not violate the security policy.

18. The article of manufacture defined in claim 11 wherein receiving the code comprises downloading the code.

19. The article of manufacture defined in claim 11 wherein receiving securely typed native code comprises receiving assembly code that has undergone a security-type preserving translation that includes annotating the assembly code with type information, and further wherein performing verification comprises verifying the type information by statically checking, with respect to a safety policy, information flow that would occur under control of the assembly code when executed.

20. An apparatus comprising:
a memory to store annotated assembly code, a verification module, an code modification module; and
a processor to execute the verification module to perform verification with respect to information flow for the annotated code based on a security policy.

21. The apparatus defined in claim 20 wherein annotations in the annotated assembly code comprise operations to mark a beginning and an ending of a region of the code in which two execution paths based on predetermined information are encountered.

22. The apparatus defined in claim 20 wherein the processor performs verification by statically checking behavior of the code to determine whether the code does not violate the security policy.

23. The apparatus defined in claim 22 wherein the code does not violate the security policy if the code, when executed, would not cause information of an identified type to flow from a device executing the code.

24. The apparatus defined in claim 20 wherein the processor removes the annotations and runs the code after determining, during verification, that the code does not violate the security policy.

25. The apparatus defined in claim 20 wherein the processor performs verification by the type information by statically checking, with respect to a safety policy, information flow that would occur under control of the assembly code when executed.

26. The apparatus defined in claim 20 further comprising wireless communication hardware and software to send and receive wireless communications.

27. A method comprising:
performing a security-type preserving translation on assembly code, including
annotating memory, stack and register contents with security levels, and
rebuilding source-level structure of the assembly code with annotations by adding operations to the assembly code to mark the beginning and ending of a security region of the assembly code in which two execution paths based on confidential information are encountered;
certifying compilation for information flow resulting from the assembly code when executed; and
sending the securely typed assembly code onto a network.
